(19) United States
(12) Patent Application Publication
(10) Pub. No.: US 2016/0241642 A1
(43) Pub. Date: Aug. 18, 2016

(54) Multimedia sharing method, registration method, server and proxy server

(71) Applicant: ZTE CORPORATION, Guangdong (CN)

(72) Inventors: Haijun LIU, Shenzhen (CN); Huoshun XU, Shenzhen (CN); Lidong LIN, Shenzhen (CN); Chuanyang MIAO, Shenzhen (CN)

(21) Appl. No.: 15/024,970

(22) PCT Filed: Oct. 29, 2014
(86) PCT No.: PCT/CN2014/089844

§ 371 Date: Mar. 25, 2016

(30) Foreign Application Priority Data
Sep. 26, 2013 (CN) 201310446465.5

(51) Int. Cl. H04L 29/08; H04L 29/06

(52) U.S. Cl. CPC H04L 67/1095; H04L 65/1023; H04L 65/60; H04L 65/105

(57) ABSTRACT

The disclosure provides a multimedia sharing method, a registration method, a server and a proxy server. The server is connected with at least two networks, and is configured to forward a multimedia sharing message between the at least two networks to implement multimedia sharing between equipments in the at least two networks. By the disclosure, the problem of being unable to implement multimedia sharing between equipments in different local area networks or between equipments outside the local network in the related art is solved, and the multimedia sharing between equipments in different local area networks or between equipments outside the local network is implemented.

### TECHNICAL FIELD

The disclosure relates to the field of communication, and in particular to a multimedia sharing method, a registration method, a server and a proxy server.

### BACKGROUND

Along with development of digital multimedia and networks, a multimedia sharing protocol is adopted for users to be allowed to transfer playing of a digital content (also called multimedia sharing) between different equipments through a local area network in the related art.

For transferring playing of a digital content between different equipments through the local area network, there has been a conventional art which may implement mutual discovery and control between equipments. For example, an existing Universal Plug and Play (UPnP) technology specifies how to send and receive a network message to implement discovery and control between equipments, the technology takes network addresses and digital codes as Identifiers (IDs) of the equipments, and a user performs selection according to the IDs of the equipments for operation.

The inventor finds that multimedia sharing in the related art is only limited to sharing in the local area network. Interconnection and media sharing with equipments in a home local area network, intercommunication and media sharing among multiple of different families and the like, with mobile equipments through the Internet, may not be implemented in the related art.

### SUMMARY

A multimedia sharing method, a registration method, a server and a proxy server are provided by embodiments of the disclosure, so as to at least solve the problem of being unable to implement multimedia sharing between equipments in different local area networks or between equipments outside the local network in the related art.

According to an embodiment of the disclosure, a server is provided, which is connected with at least two networks and configured to forward a multimedia sharing message between the at least two networks to implement multimedia sharing between equipments in the at least two networks.

The server is further configured to receive information of a proxy server in a first network and/or information, forwarded through the proxy server in the first network, of an equipment in the first network, and send the information received from the first network to a proxy server in a second network and/or to an equipment in the second network through the proxy server in the second network, wherein the information may be configured to be used during multimedia sharing between the equipment in the first network and the equipment in the second network.

The server is configured to judge whether the same multimedia sharing protocol is adopted in the at least two networks or not, and under the condition that different multimedia sharing protocols are adopted, perform multimedia sharing protocol conversion to forward the multimedia sharing message between the at least two networks.

The server is configured to add an identifier, ID, of a first network in a resource ID from the first network in the at least two networks, and send the resource ID to a second network in the at least two networks, wherein the ID of the first network is configured to identify a route of resource corresponding to the resource ID in the second network.

The server is further configured to acquire registration information of proxy servers and/or equipments in the at least two networks, and forward the multimedia sharing message according to the registration information.

According to another embodiment of the disclosure, a proxy server is further provided, which is located in a first network and configured to receive a multimedia sharing message sent by an equipment in the first network and send the multimedia sharing message to a server connected with the first network, the proxy server being further configured to receive a multimedia sharing message, forwarded through the server, from a second network, and send the multimedia sharing message from the second network to the equipment in the first network.

The proxy server is further configured to register the proxy server and/or the equipment in the first network.

According to another embodiment of the disclosure, a server is further provided, which is configured to receive a registration message, wherein the registration message is from a proxy server in a first network, and the registration message is configured to register the proxy server in the first network and/or an equipment in the first network; and the server being further configured to store registration information, wherein the equipment, registered on the server, in the first network performs multimedia sharing with an equipment in a second network by a multimedia sharing message.

The server is configured to, after receiving the registration message, authenticate the proxy server and/or the equipment in the network where the proxy server is located, register the proxy server and/or the equipment in the network where the proxy server is located on the server after the authentication is passed, and store the registration information.

The registration information stored by the server comprises: an equipment user ID, an area ID and an equipment ID, wherein the equipment user ID is configured to represent that equipments with the same equipment user ID are allowed to perform multimedia sharing; and the area ID is configured to identify an area where an address of a home service proxy server is located, and information of the area comprises at least one of: the address of the home service proxy server, a local address cluster, an Internet address cluster and a protocol adopted for multimedia sharing.

According to another embodiment of the disclosure, a multimedia sharing method is further provided, which comprising: forwarding, by a first server, a multimedia sharing message between at least two networks to implement multimedia sharing between equipments in the at least two networks, wherein the first server is connected with the at least two networks.

The step that forwarding, by a first server, the multimedia sharing message between the at least two networks comprises: judging, by the first server, whether the same multimedia sharing protocol is adopted in the at least two networks or not, and under the condition that different multimedia sharing protocols are adopted, performing multimedia sharing protocol conversion; and forwarding, by the first server, the multimedia sharing message between the at least two networks after multimedia sharing protocol conversion.

The step that forwarding, by the first server, the multimedia sharing message between the at least two networks comprises: adding, by the first server, an identifier, ID, of a first network in a resource ID from the first network in the at least two networks, and sending the resource ID to a second network in the at least two networks, wherein the ID of the first network is configured to route a resource corresponding to the resource ID in the second network.

The method is further comprising: sending, by a second server, the multimedia sharing message to the first server, wherein the second server is located in one network of the at least two networks, and the second server is connected with the first server; and sending, by the second server, the multimedia sharing message sent by the first server to an equipment in the network where the second server is located.

The method is further comprising: sending, by the second server, a registration message to a third server, wherein the registration message is configured to register the second server and/or the equipment in the network where the second server is located on the third server; and receiving, by the third server, the registration message, and registering the second server and/or the equipment in the network where the second server is located on the third server, and storing registration information.

The step that receiving, by the third server, the registration message and registering the second server and/or the equipment in the network where the second server is located on the third server comprises: after receiving the registration message, authenticating, by the third server, the second server and/or the equipment in the network where the second server is located, and registering the second server and/or the equipment in the network where the second server is located on the third server after the authentication is passed.

The registration information stored by the third server comprises: an equipment user ID, an area ID and an equipment ID, wherein the equipment user ID is configured to represent that equipments with the same equipment user ID are allowed to perform multimedia sharing; and the area ID is configured to identify an area where an address of the second server is located, and information of the area comprises at least one of: the address of the second server, a local address cluster, an Internet address cluster and a protocol adopted for multimedia sharing.

A function of the second server is achieved by the equipment in the second network.

The step that forwarding, by the first server, the multimedia sharing message comprises: acquiring, by the first server, registration information of proxy servers and/or equipment in the two networks, and forwarding the multimedia sharing message according to the registration information.

According to another embodiment of the disclosure, a registration method is provided, which comprises:

sending, by a proxy server, a registration message to a server, wherein the registration message is configured to register the proxy server and/or equipment in a network where the proxy server is located on the server; and receiving, by the server, the registration message, and registering the proxy server and/or the equipment in the network where the proxy server is located on the server, and storing registration information, wherein the equipment in the first network and registered on the server performs multimedia sharing with an equipment in a second network by a multimedia sharing message.

The step that receiving, by the server, the registration message and registering the proxy server and/or the equipment in the network where the proxy server is located on the server comprises: after receiving the registration message, authenticating, by the server, the proxy server and/or the equipment in the network where the proxy server is located, and registering the proxy server and/or the equipment in the network where the proxy server is located on the server after the authentication is passed.

The registration information stored by the server comprises: an equipment user identifier, ID, an area ID and an equipment ID, wherein the equipment user ID is configured to represent that equipments with the same equipment user ID are allowed to perform multimedia sharing; and the area ID is configured to identify an area where an address of the proxy server is located, and information of the area comprises at least one of: the address of the proxy server, a local address cluster, an Internet address cluster and a protocol adopted for multimedia sharing.

According to the embodiment of the disclosure, the server is connected with the at least two networks, and is configured to forward the multimedia sharing message between the at least two networks to implement multimedia sharing between the equipments in the at least two networks; and by the embodiment of the disclosure, the problem of being unable to implement multimedia sharing between equipments in different local area networks or between equipments outside the local network in the related art is solved, and the multimedia sharing between equipments in different local area networks or between equipments outside the local network is implemented.

### BRIEF DESCRIPTION OF THE DRAWINGS

The accompanying drawings described here are adopted to provide further understanding to the embodiments of the disclosure, and form a part of the present application. Schematic embodiments of the disclosure and description thereof are adopted to explain the technical solutions provided by the embodiments of the disclosure, instead of consisting improper limitation thereto. In the accompanying drawings:

FIG. 1 is a diagram of a server according to an embodiment of the disclosure;

FIG. 2 is a preferred networking diagram according to an embodiment of the disclosure;

FIG. 3 is a diagram of data of a multi-screen equipment gateway according to an embodiment of the disclosure;

FIG. 4 is a diagram of a media sharing message according to an embodiment of the disclosure; and

FIG. 5 is a flowchart of media sharing according to an embodiment of the disclosure.

### DETAILED DESCRIPTION OF THE EMBODIMENTS

It is important to note that embodiments in the disclosure and characteristics in the embodiments may be combined under the condition of no conflicts. The disclosure will be described below with reference to the drawings and the embodiments in detail.

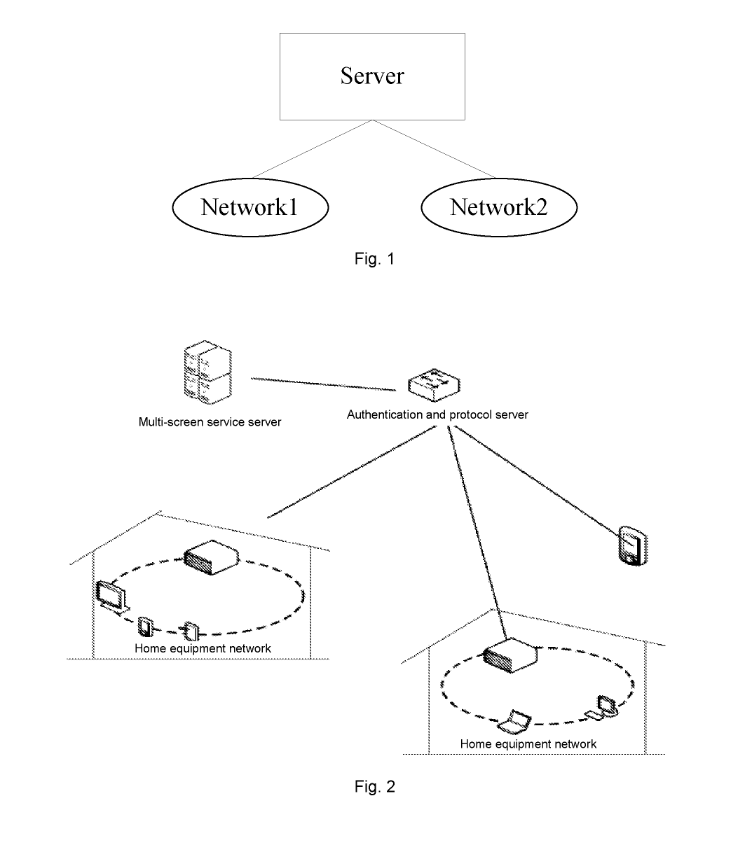

The embodiment provides a server, FIG. 1 is a diagram of a server according to an embodiment of the disclosure, and as shown in FIG. 1, the server is connected with at least two networks, and is configured to forward a multimedia sharing message between at least two networks to implement multimedia sharing between equipments in the at least two networks.

Compared with the related art, a server is added for the system, and multimedia sharing between two networks (for example, two local area networks) is implemented by the server. The server may be an independent server, and may also be a group of servers, and functions of the server described in the following embodiments may be achieved on an independent server, and may also be achieved by different servers according to the classification of the functions. In the embodiment, the functions achieved by the server may also be set in an existing server as modules, and may also be achieved by adding a new server in an existing architecture. The server may also be called as a multi-screen equipment gateway and an authentication and protocol server in the following embodiments, wherein the authentication and protocol server may be implemented by two servers, i.e. an authentication server and a protocol server.

Preferably, the server may further be configured to receive information of a proxy server in a first network and/or information, forwarded through the proxy server in the first network, of an equipment in the first network, and send the information received from the first network to a proxy server in a second network and/or to an equipment in the second network through the proxy server in the second network, wherein the information is configured to be used during multimedia sharing between the equipment in the first network and the equipment in the second network.

In the related art, different multimedia sharing protocols may be adopted for different networks, and in order to implement multimedia sharing between two equipments adopting different protocols, in a preferred embodiment, the server is configured to judge whether the same multimedia sharing protocol is adopted in the at least two networks or not, and under the condition that different multimedia sharing protocols are adopted, perform multimedia sharing protocol conversion to forward the multimedia sharing message between the at least two networks. By the preferred implementation mode, multimedia sharing between the networks adopting different protocols can be implemented.

The server may adopt multiple manners for multimedia message routing between different networks, the embodiment provides a preferred manner. In the preferred implementation manner, the server is configured to add an identifier (ID) of a first network in a resource ID from the first network in the at least two networks, and send the resource ID to a second network in the at least two networks, wherein the ID of the first network is configured to identify a route of resource corresponding to the resource ID in the second network. Such a routing manner of adding the network ID in the resource ID is relatively more convenient to be implemented, and can make processing of the server easier in a certain extent.

For higher security, in a preferred implementation mode, the proxy servers and/or equipments in the at least two networks may also be registered. Under such a condition, the server is further configured to acquire registration information of the proxy servers and/or equipments in the at least two networks, and forward the multimedia sharing message according to the registration information.

In the abovementioned embodiment, the server is required to communicate with the at least two networks, and in the embodiment, in order to facilitate the communication between a server and a network, a proxy server (which may also called as a home service proxy, or a home service proxy server) may also be added in the network. The proxy server is located in a first network, and is configured to receive a multimedia sharing message sent by an equipment in the first network and send the multimedia sharing message to a server connected with the first network; and the proxy server is further configured to receive a multimedia sharing message, forwarded through the server, from a second network, and send the multimedia sharing message from the second network to the equipment in the first network.

In such a manner of adding the proxy server in the network, a relationship between the server and different networks can be clearer, and the network architecture is more definite, so that implementation is facilitated. The proxy server is also called as a local area network proxy, a home multi-screen service proxy and local area network equipment in the following embodiments. The proxy server may be implemented by adding an independent server in the network, and the proxy server may also be implemented by the equipment(s) performing the multimedia sharing in the network.

Preferably, after the proxy server is added, in order to facilitate management on the proxy server and/or on the equipment of the network where the proxy server is located, the proxy server is further configured to register the proxy server and/or the equipment in the first network.

Registration information may be sent after the home service proxy is started, and registration information related to the equipment may also be sent after the equipment is started. Whether the equipment and/or the home service proxy are/is online or not may be known after the registration.

The abovementioned registration may be implemented by a server, and the server may be combined with the server shown in FIG. 1, and may also be separately arranged. The server may achieve a registration function. That is, the embodiment further provides a server (the server may also be called as an authentication server, a registration server or an authentication and registration server), and the server is configured to receive a registration message, wherein the registration message is from a proxy server in a first network, and the registration message is configured to register the proxy server in the first network and/or an equipment in the first network; and the server is further configured to store registration information, wherein the equipment, registered on the server, in the first network may perform multimedia sharing with an equipment in a second network by a multimedia sharing message.

For higher security, in a preferred implementation mode, an authentication function may also be added. That is, the server is preferably configured to, after receiving the registration message, authenticate the home service proxy and/or the equipment in the network where the home service proxy is located, register the home service proxy and/or the equipment in the network where the home service proxy is located on the server after the authentication is passed, and store the registration information. By the preferred implementation mode, the security is improved in a certain extent.

Preferably, the registration information stored by the server comprises: an equipment user ID, an area ID and an equipment ID, wherein the equipment user ID is configured to represent that equipments with the same equipment user ID may be allowed to perform multimedia sharing; and the area ID is configured to identify an area where an address of the home service proxy is located, and information of the area comprises at least one of: the address of the home service proxy, a local address cluster, an Internet address cluster and a protocol adopted for multimedia sharing.

Corresponding to the abovementioned servers and proxy server, the embodiment further provides a multimedia sharing method, and the content which has been described in the abovementioned embodiment will not be elaborated herein. The multimedia sharing method comprises: forwarding, by a first server, a multimedia sharing message between at least two networks to implement multimedia sharing between equipments in the at least two networks, wherein the first server is connected with the at least two networks.

Preferably, the step that forwarding, by a first server, the multimedia sharing message between the at least two networks may comprise: judging, by the first server, whether the same multimedia sharing protocol is adopted in the at least two networks or not, and under the condition that different multimedia sharing protocols are adopted, performing multimedia sharing protocol conversion; and forwarding, by the first server, the multimedia sharing message between the at least two networks after the multimedia sharing protocol conversion.

Preferably, the step that forwarding, by the first server, the multimedia sharing message between the at least two networks may comprise: adding, by the first server, an ID of a first network in a resource ID from the first network in the at least two networks, and sending the resource ID to a second network in the at least two networks, wherein the ID of the first network is configured to route a resource corresponding to the resource ID in the second network.

Preferably, the method may further comprise: sending, by a second server, the multimedia sharing message to the first server, wherein the second server is located in one network of the at least two networks, and the second server is connected with the first server; and sending, by the second server, the multimedia sharing message sent by the first server to an equipment in the network where the second server is located.

Preferably, the method may further comprise: sending, by the second server, a registration message to a third server, wherein the registration message is configured to register the second server and/or the equipment in the network where the second server is located on the third server; and receiving, by the third server, the registration message, and registering the second server and/or the equipment in the network where the second server is located on the third server, and storing registration information.

Preferably, the step of receiving, by the third server, the registration message and registering the second server and/or the equipment in the network where the second server is located on the third server may comprise: after receiving the registration message, authenticating, by the third server, the second server and/or the equipment in the network where the second server is located, and registering the second server and/or the equipment in the network where the second server is located on the third server after the authentication is passed.

Preferably, the registration information stored by the first server may comprise: an equipment user ID, an area ID and an equipment ID, wherein the equipment user ID is configured to represent that equipments with the same equipment user ID may be allowed to perform multimedia sharing; and the area ID is configured to identify an area where an address of the second server is located, and information of the area comprises at least one of: the address of the second server, a local address cluster, an Internet address cluster and a protocol adopted for multimedia sharing.

Preferably, a function of the second server is achieved by the equipment in the second network.

Preferably, the step of forwarding, by the first server, the multimedia sharing message may comprise: acquiring, by the first server, registration information of the proxy server(s) and/or equipment(s) in the two networks, and forwarding the multimedia sharing message according to the registration information.

Corresponding to the abovementioned server configured for registration, a registration method is further provided, which comprises the following steps:

Step 102: sending, by a second server (i.e. a proxy server), a registration message to the third server (i.e. the abovementioned server configured for registration), wherein the registration message is configured to register the second server and/or equipment in a network where the second server is located on the third server; and

Step 104: receiving, by the third server, the registration message, and registering the second server and/or the equipment in the network where the second server is located on the third server, and storing registration information, wherein the equipment in the first network and registered on the third server may perform multimedia sharing with an equipment in a second network by a multimedia sharing message.

Preferably, the step of receiving, by the third server, the registration message and registering the second server and/or the equipment in the network where the second server is located on the third server may comprise: after receiving the registration message, authenticating, by the third server, the second server and/or the equipment in the network where the second server is located, and registering the second server and/or the equipment in the network where the second server is located on the third server after the authentication is passed.

Preferably, the registration information stored by the first server may comprise: an equipment user ID, an area ID and an equipment ID, wherein the equipment user ID is configured to represent that equipments with the same equipment user ID may be allowed to perform multimedia sharing; and the area ID is configured to identify an area where an address of the second server is located, and information of the area comprises at least one of: the address of the second server, a local address cluster, an Internet address cluster and a protocol adopted for multimedia sharing.

Description will be made below with reference to a preferred embodiment.

In the following preferred embodiment, hybrid protocol and hybrid network multi-screen intercommunication and media sharing of multi-screen equipment may be provided by a multi-screen equipment gateway. The preferred embodiment involves the multi-screen equipment gateway, and is configured to manage registered equipment, a local network of the equipment and an equipment user, forward an intercommunication message and a media sharing message and convert a protocol message; and a local area network proxy, configured to receive a local message, encapsulate the local message and send the encapsulated local message to the multi-screen equipment gateway, and broadcast (multicast) the message from the multi-screen equipment gateway in a local area network.

A method provided by the preferred embodiment may comprise the following steps:

Step 1: an equipment is registered on the multi-screen equipment gateway;

Step 2: the local area network proxy forwards a message; and

Step 3: the multi-screen equipment gateway analyzes a protocol, and forwards the message.

Preferably, an equipment with an Internet address may be directly registered on the multi-screen equipment gateway.

Preferably, an equipment in the local area network is registered to the multi-screen equipment gateway after the local area network proxy receives the message which is broadcast (multicast) and sends the message to the multi-screen equipment gateway, and the multi-screen equipment gateway records each equipment in the local area network and an address of the equipment in the local area network.

Preferably, the multi-screen equipment gateway receives a media sharing protocol message, performs the protocol conversion and the replacement of an address field in the message according to a protocol of a destination equipment, and then sends the message to the destination equipment.

By the steps, equipments of multiple local area networks and Internet equipments may intercommunicate with each other and implementing media sharing.

FIG. 2 is a preferred networking diagram according to an embodiment of the disclosure, and FIG. 2 shows each device and their relationships.

In FIG. 2, there are four types of equipments and two types of scenarios. The three types of equipments are a multi-screen authentication server and protocol server, a multi-screen home service proxy such as a set-top box and a home Internet gateway, home multimedia service equipments such as a mobile phone, tablet, personal computer and notebook computer connected with Wireless Fidelity (WiFi), and Internet multimedia service equipments such as a mobile phone accessing a mobile network and a multi-screen service server in the Internet. The two types of scenarios are multi-screen sharing between multimedia service equipments in a home network (local area network) and multi-screen sharing between each multimedia service equipment in the home network and Internet multimedia service equipment (Internet). A solution to the first scenario is provided in a conventional art, for example, a Digital Living Network Alliance (DLNA)/UPnP technology, an Airplay technology and an intelligent grouping and resource sharing technology, and these technologies have similarities of mutual discovery of equipments and mutual sharing of multimedia contents in a local area network. The scenario corresponds to “home equipment network” in FIG. 2, and it is unnecessary to connect the network in the figure to an external network. The second scenario is multimedia content sharing between equipments under a hybrid Internet and local area network condition, and the embodiment provides a solution to the second scenario to implement multimedia content sharing between different equipments in the family and between an equipment connected to the Internet and an equipment in the family by a gateway under the second scenario.

In FIG. 2, each equipment in the home equipment network still adopts the conventional art such as DLNA/UPnP and Airplay for media sharing without modifying existing software and hardware; and a multi-screen home service proxy is added in the home equipment network, and the equipment:

(1) supports a protocol such as DLNA/UPnP and Airplay, and is simultaneously connected with a multi-screen authentication server and a protocol server in the Internet;

(2) may send multi-screen equipment information collected by the protocol such as DLNA/UPnP and Airplay to a server and multicast/broadcast other equipment protocol information, transmitted by the server, of such as DLNA/UPnP and Airplay in the home equipment network;

(3) may send a multi-screen multimedia sharing message, transmitted by the server for multi-screen equipment(s), based on the protocol such as DLNA/UPnP and Airplay, to the multi-screen equipment(s) in the home equipment network; and

(4) may send a multi-screen multimedia sharing message based on the protocol such as DLNA/UPnP and Airplay, sent by the multi-screen equipment(s) in the home equipment network, to the server.

The multi-screen home service proxy device may be implemented by adding a software function to existing equipment such as a set-top box and a home Internet gateway, and such equipment may be simultaneously connected to an equipment in the home network and to the Internet.

In FIG. 2, the multi-screen authentication and protocol server is interconnected with the multi-media home service proxy, and is interconnected with multimedia service equipment of a mobile network or a telecommunication network, such as a mobile phone and a computer. Here, the equipment such as the mobile phone and the computer may use DLNA/UPnP, Airplay technologies with a modified equipment discovery function to perform multimedia content sharing with other equipment through the multi-screen authentication server and the protocol server. Of course, other protocol technologies may also be used. The multi-screen authentication server and the protocol server have, besides of the function of connecting above equipment(s), another important function of implementing protocol conversion of multimedia sharing protocols. The functions of the multi-screen authentication server and the protocol server comprise:

(1) equipment information management and publication: registration information of the multi-screen home service proxy and registration information of the Internet multimedia service equipment are received, and packet mapping information of the multi-screen home service proxy with the Internet multimedia service equipment, and with the multi-screen equipment in the home equipment network is recorded;

(2) protocol message analysis and conversion: the server has multiple protocol message receiving and processing modules, which receive protocol messages of DLNA, UPnP, Airplay and the like respectively, analyze the messages and convert the messages into corresponding protocol messages supported by destination equipment according to the destination equipment; and

(3) management and mapping of Uniform Resource ID (URI) inside and outside of the protocol message(s): the URI here comprise the Uniform Resource Locator (URL), the Uniform Resource Name (URN) and the equipment address. The URI in the protocol message comprises a URL and the like where multimedia content indicated in the message is located, and the server needs to regenerate a URL according to a local area network where the multi-screen home service proxy is located to ensure correct routing access when the equipment outside the home equipment network accesses the multimedia content; for example, the local area networks of the two home networks both are 192.168.1.*, their multi-media home service proxies have an address of 192.168.1.1 respectively, and when an equipment with 192.168.1.10 in the first home network indicates that a URL of a multimedia content vclip001 on an equipment with 192.168.1.11 is HTTP://192.168.1.11/vclip001.mpg, the server maps the URL into HTTP://192.168.1.1/vclip001.mpg@remotedev, and then sends a message including the converted URL to the multi-screen home service proxy in the second home network, and the multi-screen home service proxy in the second home network multicasts/broadcasts/unicasts the converted URL in multi-screen equipment(s) in the second home network; and when the multi-screen equipment in the second home network accesses the multimedia content with HTTP://192.168.1.1/vclip001.mpg@remotedev, the multi-screen home service proxy in the second home network sends an access request message to the server, the server analyzes the message according to the address of the multi-screen home service proxy in the second home network, remaps HTTP://192.168.1.1/vclip001.mpg@remotedev back into HTTP://192.168.1.11/vclip001.mpg, and sends the message to the multi-screen home service proxy of the first home network, the multi-screen home service proxy of the first home network establishes a connection with the equipment of 192.168.1.11, accesses the multimedia content thereon and forwards the multimedia content to the server, the server forwards the multimedia content to the multi-screen home service proxy of the second home network, and the multi-screen home service proxy of the second home network forwards the multimedia content to the multi-screen equipment, which sends the request, in the second home network.

In FIG. 2, the multi-screen service server is connected with the multi-screen authentication and protocol server, and the multi-screen service server provides public or customized multi-screen service, including multimedia synchronization information service, advertisement service and the like.

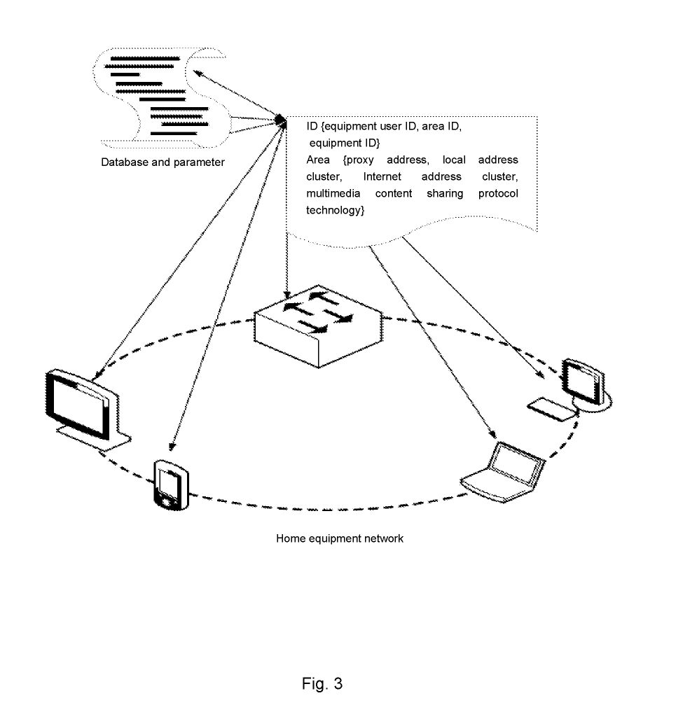

FIG. 3 is a diagram of data of a multi-screen equipment gateway according to an embodiment of the disclosure, and FIG. 3 shows that the authentication and protocol server receives the registration information of each multi-screen home service proxy and the registration information of the Internet multimedia service equipment and records the packet mapping information of the multi-screen home service proxy with the Internet multimedia service equipment, and with the multi-screen equipment in the home equipment network. Data on the server comprises ID {equipment user ID, area ID, equipment ID}; and

area {multi-screen home service proxy address, local address cluster, Internet address cluster, multimedia content sharing protocol technology}.

The authentication server sets an equipment user ID for multi-screen sharing, and the equipments associated with the equipment user ID may be allowed to perform multi-screen sharing; and the area ID, i.e. an area where the address of the multi-screen home service proxy is located, the ID of each associated equipment and multi-screen related information such as address and protocol equipment type (such as DLNA Database Management System (DMS), UPnP media server and Domain Name System (DNS) server) of the equipment are recorded in the equipment user ID.

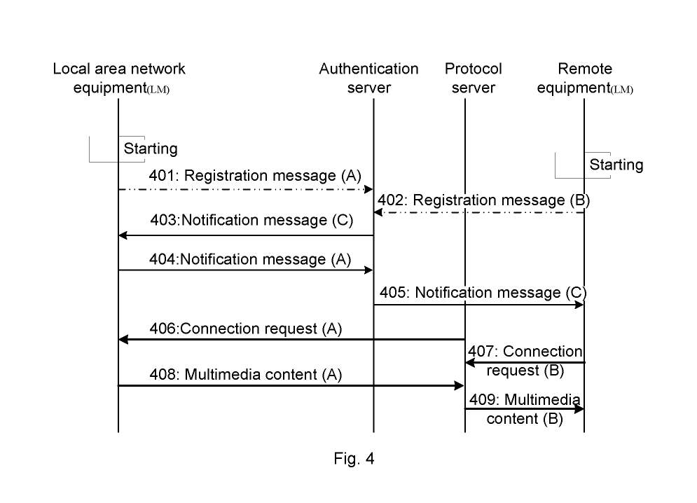

FIG. 4 is a flowchart of transmission of a media sharing message according to an embodiment of the disclosure. In FIG. 4, a local area network equipment corresponds to the abovementioned multi-screen home service proxy, the abovementioned server(s) is divided into an authentication server and a protocol server in the embodiment, and a remote equipment corresponds to the abovementioned Internet multimedia service equipment. As shown in FIG. 4, the flow comprises the following steps.

Step 401: after being started, the local area network equipment sends a registration message (Registration) to the authentication server.

In the step, the local area network equipment may be embedded with an address of the authentication server. Preferably, the local area network equipment also sends the registration message to the authentication server when the local area network equipment receives a message indicating that other multi-screen service equipment in the local area network is started. After receiving the registration message, the authentication server queries pre-stored data such as an equipment user ID, and may require the local area network equipment to provide information required for the authentication, such as a username, a password or another certificate, and the local area network equipment responds to a request message according to an agreement. The authentication server provides a protocol server address for the local area network equipment after the authentication succeeds, and records information, such as an online state of the equipment.

Step 402: the remote equipment sends a registration message to the authentication server when the remote equipment is required to initiate multi-screen sharing service, for example, when the remote equipment is started.

In the step, the remote equipment is embedded with the address of the authentication server. The authentication server may require the remote equipment to provide the information required for the authentication; and after the authentication succeeds, the authentication server records information, such as an online state of the equipment.

Step 403: the authentication server sends a C-type notification message (Notification) to the local area network equipment.

In the step, the authentication server, after storing the information that the remote equipment is online, sends the notification message to the local area network equipment. The message content of the notification message is organized by the protocol server according to a protocol message acceptable for the local area network equipment and an address of the local area network equipment, and then the notification message is sent to the local area network equipment by the authentication server. For example, a UPnP Simple Service Discovery Protocol (SSDP) NOTIFY message is organized, wherein a target address is HOST:239.255.255.250:1900, LOCATION is the address of the local area network equipment, and a Universally Unique Identifier (UUID) is provided by the remote equipment or generated by the protocol server.

Step 404: the local area network equipment sends an A-type notification message to the authentication server.

In the step, if other multi-screen service equipment in the local area network sends messages, the local area network equipment receives and forwards these messages, of which content includes complete protocol messages sent by the other multi-screen service equipment, for example, a complete UPnP SDDP NOTIFY message, a UPnP Media Server Content Distribution Service (CDS) query message and a Session Initiation Protocol (SIP) message.

Step 405: the authentication server sends a C-type notification message to the remote equipment.

In the step, the authentication server sends the notification message of the equipment which is recorded in the online state to the remote equipment, wherein the message sent to the remote equipment is in a protocol message format acceptable for the remote equipment; and an address, multimedia resource URI and message format in the message are mapped and interpreted by the protocol server.

Step 406: the remote equipment initiates a B-type connection request (Connection) to the protocol server.

In the step, the remote equipment may initiates the connection request according to own protocol technology.

Step 407: the protocol server initiates an A-type connection request to the local area network equipment.

In the step, the protocol server may update a URL or an address in the request message according to a recorded mapping relationship, interpret the message to generate a new message A and send the message A to the local area network equipment. The local area network equipment initiates a connection request to equipment in the local area network according to the abovementioned flow. In this step, the request message received by the equipment in the local area network and the message forwarded by the local area network are all messages organized and generated by the protocol server, and as mentioned in the previous steps, the local area network equipment does not convert content of the messages.

If multimedia content is acquired in a Hyper Text Transfer Protocol (HTTP) manner, the multimedia content has been shared in the step, and subsequent steps are not required any more.

Step 408: the local area network equipment sends the multimedia content to the protocol server.

For example, multimedia content data is transmitted among the equipment in the local area network, the local area network equipment and the protocol server by using a Real-time Transport Protocol/Real-time Transport Control Protocol (RTP/RTCP). The protocol server may perform multimedia format transcoding in the step.

If the protocol server is not required to perform multimedia format transcoding, the protocol server may also negotiate about direct establishment of an RTP/RTCP connection of the local area network equipment and the remote equipment in the message in Step 407.

Step 409: the protocol server forwards the multimedia content to the remote equipment.

In the step, the protocol server may transmit the multimedia content data to the remote equipment by using RTP/RTCP.

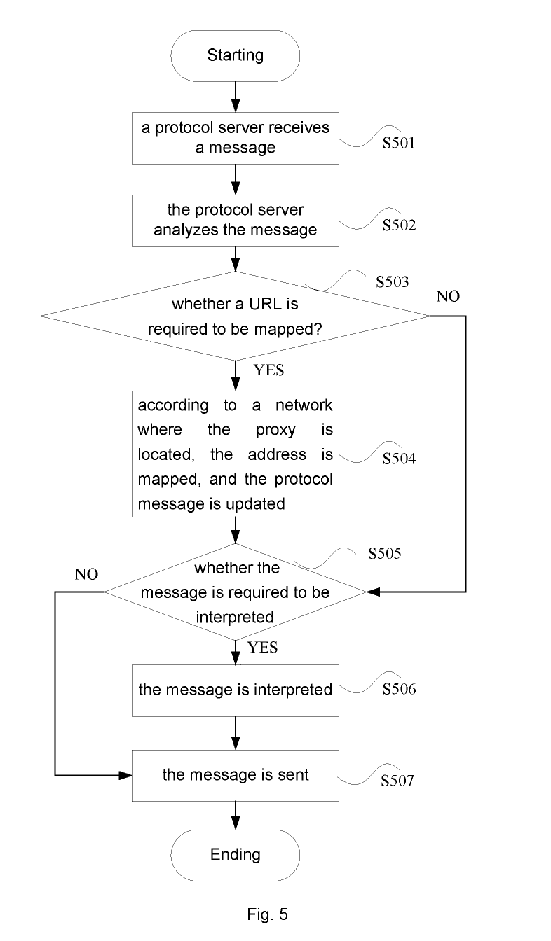

FIG. 5 is a flowchart of media sharing according to an embodiment of the disclosure. A processing flow of a protocol server is described in the figure, and as shown in FIG. 5, the flow comprises the following steps.

Step 501: the protocol server receives a message.

In the step, the protocol server supports multiple protocol messages. When sending a registration message to an authentication server, each multi-screen home service proxy reports a protocol technology adopted for multimedia sharing between equipments in a local area. When sending a registration message to the authentication server, each Internet multimedia service equipment reports a protocol technology adopted for the multimedia sharing of the Internet multimedia service equipment, and these protocol technologies comprise a DLNA/UPnP protocol technology, or an Airplay protocol technology, or an intelligent grouping and resource sharing protocol technology or the like. The protocol server obtains, by the authentication server, protocol technology information of the equipment in the area where the multi-screen home service proxy is located, and the Internet multimedia service equipment.

A software module on the protocol server comprises the startup of multiple protocol technology servers such as a DLNA protocol message receiving server, a multicast-DNS and DNS-service discovery (Airplay) message receiving server, an HTTP server, an SIP server and the like.

The protocol server receives protocol message data from the multi-screen home service proxy and the Internet multimedia service equipment.

Step 502: the protocol server analyzes the message.

In the step, the protocol server analyzes the received protocol message, analyzes a URL or an address in the message according to the protocol, and judges whether it is necessary to interpret the message into a corresponding protocol message or not according to an destination equipment of the message.

Step 503: it is judged whether it is required to map a network address or not; if YES, Step 504 is executed, otherwise Step 505 is executed.

Preferably, the conditions of the judgment mainly comprise: (1) whether the message is from a multi-screen home service proxy or not and whether the message comprises a multimedia resource URL or not; and (2) whether the message is sent to the multi-screen home service proxy or not and whether the message comprises the multimedia resource URL or not.

Step 504: according to a network where the proxy is located, the address is mapped, and the protocol message is updated.

In this step, content for mapping and updating the message may preferably comprise: (1) it is judged whether the message is from a multi-screen home service proxy A or not; if the message is from the multi-screen home service proxy A, it is necessary to replace the equipment address or URL in the message with an address of the multi-screen home service proxy A, and record a replacement relationship; then it is judged whether the message comprises the multimedia resource URL or not, and if YES, the address in the URL is replaced with the address of the multi-screen home service proxy A, an ID is appended, and such a mapping relationship is recorded; and (2) it is judged whether the message is sent to a multi-screen home service proxy B or not; if the message is sent to the multi-screen home service proxy B, it is necessary to replace the equipment address or URL in the message with an address of the multi-screen home service proxy B, and record the replacement relationship; then it is judged whether the message comprises the multimedia resource URL or not, and if YES, the address in the URL is replaced with the address of the multi-screen home service proxy B, an ID is appended, and such a mapping relationship is recorded.

Step 505: it is judged whether the message is required to be interpreted or not; if YES, Step 506 is executed, otherwise Step 507 is executed.

In this step, above judgment is performed according to whether a protocol of the received message is the same as a message protocol adopted by the destination equipment or not, and if NO, the message is required to be interpreted, and Step 506 is executed.

Step 506: the message is interpreted.

For example, a DLNA multicast message is interpreted into multi-DNS and DNS-SD messages and the like.

Step 507: the message is sent.

In the step, the message may preferably be sent to the destination equipment according to the address and protocol adopted by the destination equipment.

In the abovementioned embodiment, a television, a player, a storage server, a computer, a sound equipment, a sound box, a projector, a set-top box and the like may all be employed as the multimedia sharing equipment, and types of the equipment are not limited in the abovementioned embodiment.

The abovementioned flows are embodiments implementing the disclosure and not intended to limit implementation of the disclosure with the embodiments and limit methods executed by specific flows, the disclosure may also be implemented in similar manners, such as names representative of units and various message types, and differences only lie in naming form, specific message content and the like.

The network-related embodiment is applicable to the Internet Protocol (IP) network supported by communication networks such as Institute of Electrical and Electronic Engineers 802.3 (IEEE 802.3), IEEE 802.11b/g/n, POWELINE, CABLE, Public Switched Telephone Network (PSTN), 3rd Generation Partnership Project (3GPP)-based networks and a 3GPP2 network, and an operating system of each device is applicable to a UNIX-type operating system, a WINDOWS-type operating system, an ANDROID-type operating system and an IOS operating system.

Obviously, those skilled in the art should know that each module or step of the disclosure may be implemented by a universal computing device, and the modules or steps may be concentrated on a single computing device or distributed on a network formed by a plurality of computing devices, and may optionally be implemented by program codes executable for the computing devices, so that the modules or steps may be stored in a storage device for execution with the computing devices, or may form each integrated circuit module respectively, or multiple modules or steps therein may form a single integrated circuit module for implementation. As a consequence, the disclosure is not limited to any specific hardware and software combination.

The above is only the preferred embodiment of the disclosure and not intended to limit the disclosure, and for those skilled in the art, the disclosure may have various modifications and variations. Any modifications, equivalent replacements, improvements and the like within the spirit and principle of the disclosure shall fall within the scope of protection of the disclosure.

### INDUSTRIAL APPLICABILITY

From the above, the multimedia sharing method, registration method, server and proxy server provided by the embodiment of the disclosure have beneficial effects as follows: the problem of being unable to implement multimedia sharing between equipments in different local area networks or between equipments outside the local network in the related art is solved, and the multimedia sharing between equipments in different local area networks or between equipments outside the local network is implemented.

1. A server, connected with at least two networks and configured to forward a multimedia sharing message between the at least two networks to implement multimedia sharing between equipments in the at least two networks.

2. The server as claimed in claim 1, wherein the server is further configured to receive information of a proxy server in a first network and/or information, forwarded through the proxy server in the first network, of an equipment in the first network, and send the information received from the first network to a proxy server in a second network and/or to an equipment in the second network through the proxy server in the second network, wherein the information is configured to be used during the multimedia sharing between the equipment in the first network and the equipment in the second network.

3. The server as claimed in claim 1, wherein the server is configured to judge whether the same multimedia sharing protocol is adopted in the at least two networks or not, and under the condition that different multimedia sharing protocols are adopted, perform multimedia sharing protocol conversion to forward the multimedia sharing message between the at least two networks.

4. The server as claimed in claim 1, wherein the server is configured to add an identifier, ID, of a first network in a resource ID from the first network in the at least two networks, and send the resource ID to a second network in the at least two networks, wherein the ID of the first network is configured to identify a route of resource corresponding to the resource ID in the second network.

5. The server as claimed in claim 1, wherein the server is further configured to acquire registration information of proxy servers and/or equipments in the at least two networks, and forward the multimedia sharing message according to the registration information.

6. A proxy server, located in a first network and configured to receive a multimedia sharing message sent by an equipment in the first network and send the multimedia sharing message to a server connected with the first network;
the proxy server being further configured to receive a multimedia sharing message, forwarded through the server, from a second network, and send the multimedia sharing message from the second network to the equipment in the first network.

7. The proxy server as claimed in claim 6, wherein the proxy server is further configured to register the proxy server and/or the equipment in the first network.

8. A server, configured to receive a registration message, wherein the registration message is from a proxy server in a first network, and the registration message is configured to register the proxy server in the first network and/or an equipment in the first network; and
the server being further configured to store registration information, wherein the equipment, registered on the server, in the first network performs multimedia sharing with an equipment in a second network by a multimedia sharing message.

9. The server is claimed in claim 8, wherein the server is configured to, after receiving the registration message, authenticate the proxy server and/or the equipment in the first network where the proxy server is located, register the proxy server and/or the equipment in the network where the proxy server is located on the server after the authentication is passed, and store the registration information.

10. The server as claimed in claim 8, wherein the registration information stored by the server comprises: an equipment user ID, an area ID and an equipment ID, wherein the equipment user ID is configured to represent that equipments with the same equipment user ID are allowed to perform multimedia sharing; and the area ID is configured to identify an area where an address of a home service proxy server is located, and information of the area comprises at least one of: the address of the home service proxy server, a local address cluster, an Internet address cluster and a protocol adopted for multimedia sharing.

11. A method for multimedia sharing, comprising:
forwarding, by a first server, a multimedia sharing message between at least two networks to implement multimedia sharing between equipments in the at least two networks, wherein the first server is connected with the at least two networks.

12. The method as claimed in claim 11, wherein forwarding, by the first server, the multimedia sharing message between the at least two networks comprises:
judging, by the first server, whether the same multimedia sharing protocol is adopted in the at least two networks or not, and under the condition that different multimedia sharing protocols are adopted, performing multimedia sharing protocol conversion; and
forwarding, by the first server, the multimedia sharing message between the at least two networks after the multimedia sharing protocol conversion.

13. The method as claimed in claim 11, wherein forwarding, by the first server, the multimedia sharing message between the at least two networks comprises:
adding, by the first server, an identifier, ID, of a first network in a resource ID from the first network in the at least two networks, and sending the resource ID to a second network in the at least two networks, wherein the ID of the first network is configured to identify a route of resource corresponding to the resource ID in the second network.

14. The method as claimed in claim 11, further comprising:
sending, by a second server, the multimedia sharing message to the first server, wherein the second server is located in one network of the at least two networks, and the second server is connected with the first server; and
sending, by the second server, the multimedia sharing message sent by the first server to an equipment in the network where the second server is located.

15. The method as claimed in claim 14, further comprising:
sending, by the second server, a registration message to a third server, wherein the registration message is configured to register the second server and/or the equipment in the network where the second server is located on the third server; and
receiving, by the third server, the registration message, and registering the second server and/or the equipment in the network where the second server is located on the third server, and storing registration information.

16. The method as claimed in claim 15, wherein receiving, by the third server, the registration message and registering the second server and/or the equipment in the network where the second server is located on the third server comprises:
after receiving the registration message, authenticating, by the third server, the second server and/or the equipment in the network where the second server is located, and registering the second server and/or the equipment in the network where the second server is located on the third server after the authentication is passed.

17. The method as claimed in claim 15, wherein the registration information stored by the third server comprises: an equipment user ID, an area ID and an equipment ID, wherein the equipment user ID is configured to represent that equipments with the same equipment user ID are allowed to perform multimedia sharing; and the area ID is configured to identify an area where an address of the second server is located, and information of the area comprises at least one of: the address of the second server, a local address cluster, an Internet address cluster and a protocol adopted for multimedia sharing.

18. The method as claimed in claim 13, wherein a function of the second server is achieved by the equipment in the second network.

19. The method as claimed in claim 11, wherein forwarding, by the first server, the multimedia sharing message comprises:
acquiring, by the first server, registration information of proxy servers and/or equipments in the at least two networks, and forwarding the multimedia sharing message according to the registration information.

20. A registration method, comprising:
sending, by a proxy server, a registration message to a server, wherein the registration message is configured to register the proxy server and/or an equipment in a network where the proxy server is located on the server; and
receiving, by the server, the registration message, and registering the proxy server and/or the equipment in the network where the proxy server is located on the server, and storing registration information, wherein the equipment in the first network and registered on the server performs multimedia sharing with an equipment in a second network by a multimedia sharing message.

21. The method as claimed in claim 20, wherein receiving, by the server, the registration message and registering the proxy server and/or the equipment in the network where the proxy server is located on the server comprises:
after receiving the registration message, authenticating, by the server, the proxy server and/or the equipment in the network where the proxy server is located, and registering the proxy server and/or the equipment in the network where the proxy server is located on the server after the authentication is passed.

22. The method as claimed in claim 20, wherein the registration information stored by the server comprises: an equipment user identifier, ID, an area ID and an equipment ID, wherein the equipment user ID is configured to represent that equipments with the same equipment user ID are allowed to perform multimedia sharing; and the area ID is configured to identify an area where an address of the proxy server is located, and information of the area comprises at least one of: the address of the proxy server, a local address cluster, an Internet address cluster and a protocol adopted for multimedia sharing.
